(19) United States
(12) Patent Application Publication
(10) Pub. No.: US 2018/0130010 A1
(43) Pub. Date: May 10, 2018

(54) METHOD AND SYSTEM FOR DATA TRACKING AND DELIVERY

(71) Applicant: Bank of America Corporation, Charlotte, NC (US)

(72) Inventor: Manu Kurian, Dallas, TX (US)

(21) Appl. No.: 15/344,057

(22) Filed: Nov. 4, 2016

(51) Int. Cl. G06Q 10/08; G06F 17/30; G06Q 30/06

(52) U.S. Cl. CPC G06Q 10/087; G06Q 10/083; G06Q 30/0635; G06F 17/30879

(57) ABSTRACT

Aspects of the present disclosure are directed to electronic computer implemented tracking method and system for a product. In one aspect, a plurality of computer readable records are electronically maintained and stored in a computer readable database. In one step, a temporary virtual account with EDI data payload including a transaction record attribute, vendor record attribute, and a location transfer request attribute for designating a processing location of a product is generated by an exchange computer system. Responsive to a location transfer request attribute, a step involves transmitting, via the computer-based data communications network, EDI data payload representative of a transfer mode attribute and subsequent transfer request attribute for a downstream processing location.

### BACKGROUND

Moore's law predicted that the number of transistors on a computer chip would double every two years while the chip's price would remain constant. “Moore's law” meant consumers could buy the same technology two years later for about the same price. Fifty years later, Moore's law prediction has endured to the idea that technology companies have recognized Moore's law as a benchmark they must meet, or fall behind in the market. Patrons have come to expect technological products to be faster, cheaper, and more compact over time. This expectation seems to have driven trends of rapid growth in computing power, smaller devices, better battery life, ability to connect to the Internet, and reduction in cost and big data. The age of big data is upon us. There is a need to improve the technological processing of the big data in new computing era.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of the present disclosure are directed to electronic computer implemented tracking method and system for a product. In one aspect, a plurality of computer readable records are electronically maintained and stored in a computer readable database. In one step, a temporary virtual account with EDI data payload including a transaction record attribute, vendor record attribute, and a location transfer request attribute for designating a processing location of a product is generated by an exchange computer system. Next, a step includes electronically via a secure computer-based data communications network, receiving EDI data payload representative of the transaction record attribute and the location transfer request attribute; and responsive to the location transfer request attribute, a step involves transmitting, via the computer-based data communications network, EDI data payload representative of a transfer mode attribute and subsequent transfer request attribute for a downstream processing location.

Aspects of the present disclosure are directed to electronic computer implemented tracking method and system for a product. One or more non-transitory computer readable media storing computer executable instructions that, when executed by at least one processor, cause the at least one processor to perform a digital tracking method, comprise: electronically maintaining a plurality of computer readable records in an computer readable database. Next the processor computer executable instructions generates a temporary virtual account with EDI data payload including a transaction record attribute, vendor record attribute, and a location transfer request attribute for designating a processing location of a product. Further, the computer executable instructions receives EDI data payload representative of the transaction record attribute and the location transfer request attribute electronically via an IPSEC computer-based data communications network tunnel. Then responsive to the location transfer request attribute, transmitting, via the computer-based data communications network, EDI data payload representative of a transfer mode attribute and subsequent transfer request attribute for a subsequent physical processing location.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a digital computing environment in which certain aspects of the present disclosure may be implemented;

FIG. 2 is an illustrative block diagram of workstations and servers that may be used to implement the processes and functions of certain embodiments of the present disclosure;

FIGS. 3A-3B are an illustrative functional block diagram of workstations, database and servers that may be used to implement the processes and functions of certain embodiments;

FIG. 4 is an example flow chart of an illustrative method for data tracking and delivery in accordance with at least one aspect of the present disclosure;

FIG. 5 is a schematic diagram of a logistical device with a data tracking device in accordance with at least one aspect of the present disclosure; and

FIG. 6 is an example flow chart of an illustrative method for data tracking and delivery in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

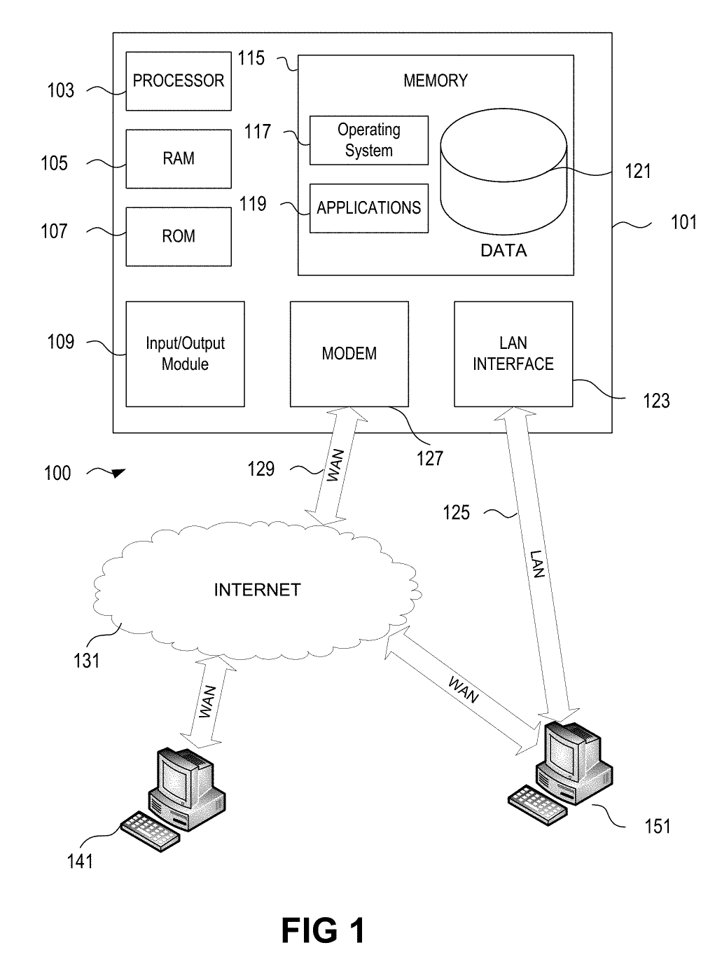

FIG. 1 illustrates a block diagram of an specific programmed computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide computer readable instructions to processor 103 for enabling server 101 to perform various technologic functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with vendors and patrons, allowing functional interoperability between different elements located at multiple physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, mobile computing devices, e.g., smart phones, wearable computing devices, tablets, distributed computing environments that include any of the above systems or devices, and the like.

The disclosure may be described in the context of computer-executable instructions, such as program modules, being executed by a computer. Generally, program modules include routines, programs, objects, components, data structures, etc. that perform particular tasks or implement particular computer data types. The disclosure may also be practiced in distributed computing environments where tasks are performed by remote processing devices that are linked through a communications network. In a distributed computing environment, program modules may be located in both local and remote computer storage media including memory storage devices.

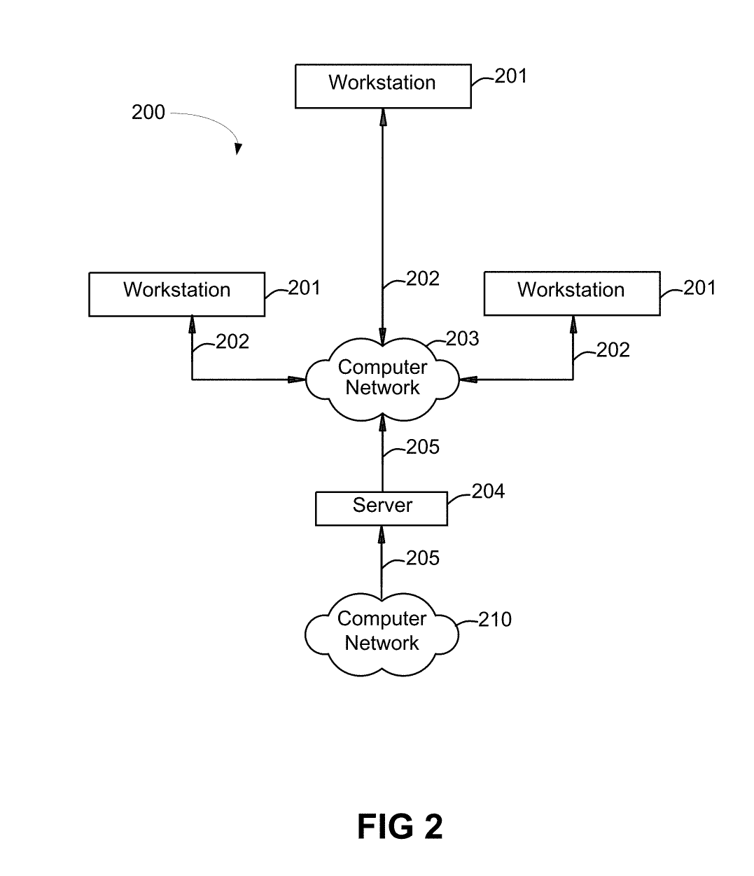

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

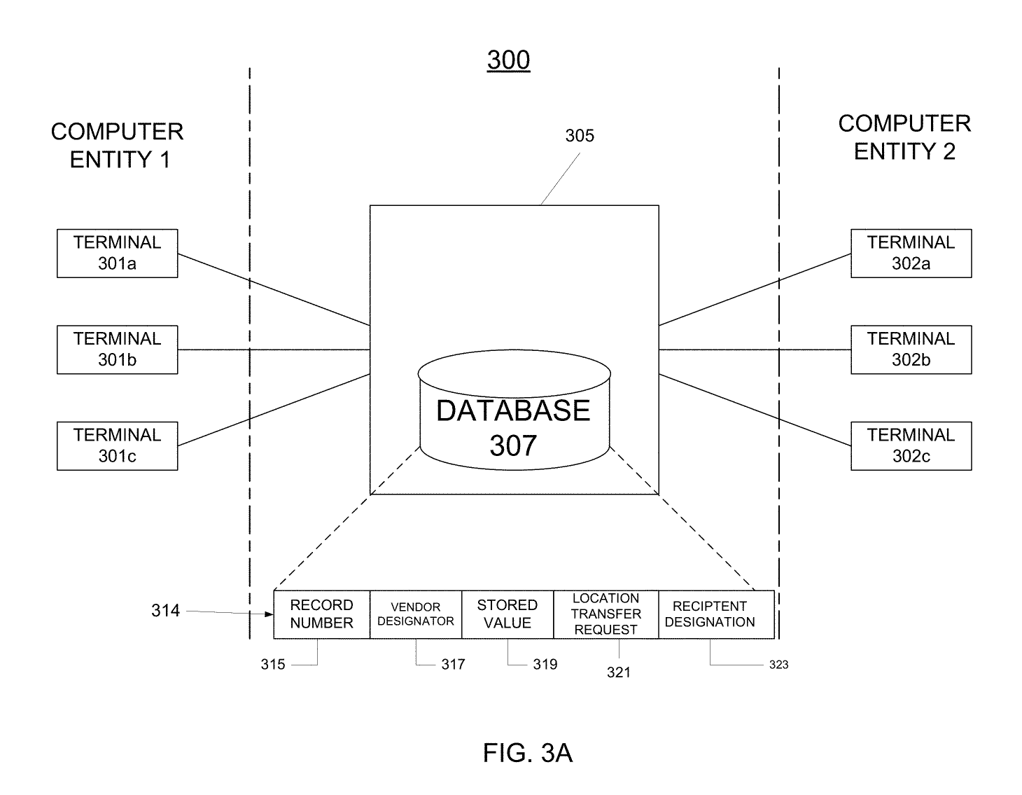

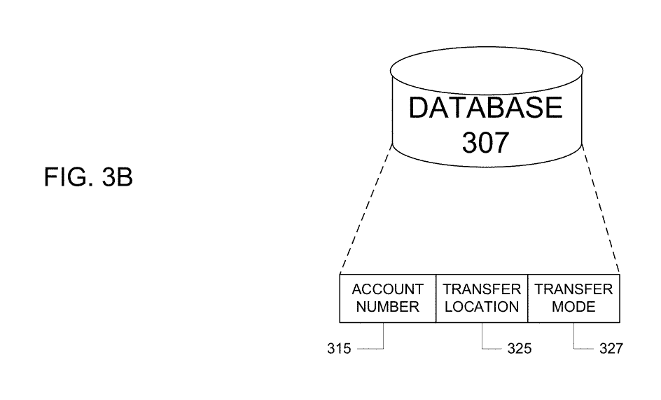

FIG. 3 illustrates an example of representative infrastructure according to some embodiments in the disclosure. The different entity users 301a-301c (such as vendors), via terminals/workstations, electronically communicates with a plurality of different entities (such as, purchasers) devices 302a-302c, through the electronic exchange logistics processing system 300 including server 305 and electronic database 307. In one embodiment, users execute commands with terminals/workstations to exchange information with the processing system 300 such that the identity of the vendor and purchasers are shielded from each order. These terminals may be standard personal computers as are known in the art. In alternative embodiments, the users may use hand-held or other portable electronic devices as known in the art to communicate with the system 300. The system includes, for example and without limitation, server 305. Server 305 may include a mail server, which may be used to receive and send data via email or over the internet. The system 300 may use various attribute data in the Electronic Data Interchange (EDI) format for electronic tracking of specific data as discussed in the foregoing. Server 305 can process an EDI messages sent through the exchange system 300 to improve computer processing and add functionally to electronic logistical tracking systems thereby bring new tangible improved electronic tracking functions to the technology area of transactions and delivery mode.

FIGS. 3A-3B are merely illustrative and the number of, users and/or user terminals, vendors, servers and databases is not in any way limited. Furthermore, although various embodiments are described in the context of a single system, one of ordinary skill in the art may appreciate that the described functionality may be implemented across multiple systems. Moreover, a web site may be mirrored at additional systems in the network and, if desired, one or more management systems or other computer resources may be used to facilitate various functions. The computer program at the system 300 includes appropriate screen routines for generating a set of screens that together comprise a graphical user interface for the site.

The system 300 can provide messages in the communication cycle in an authenticated format, secure for each party that would be invited or authorized to be a part of the data tracking exchange. In some constructions, would have to meet certain factors of data security. For example, an IPSEC circuit is commonly to pertain to IP Security, a set of protocols to support secure exchange of packet at the IP layer in a TCP/IP network system. IPSEC systems have been deployed widely to implement Virtual Private Networks (VPNs). Under an IPSEC system, at least two encryption modes are supported: Transport and Tunnel. Transport mode encrypts only the payload portion of each packet, but leaves the header. The Tunnel mode encrypts both the header and the payload. On the receiving side, an IPSEC-compliant device decrypts each packet. The methods and features recited herein further may be implemented through any number of non-transitory computer readable media that are able to store computer readable instructions. Examples of non-transitory computer readable media that may be used include RAM, ROM, EEPROM, flash memory or other memory technology, CD-ROM, DVD, or other optical disc storage, magnetic cassettes, magnetic tape, magnetic storage and the like.

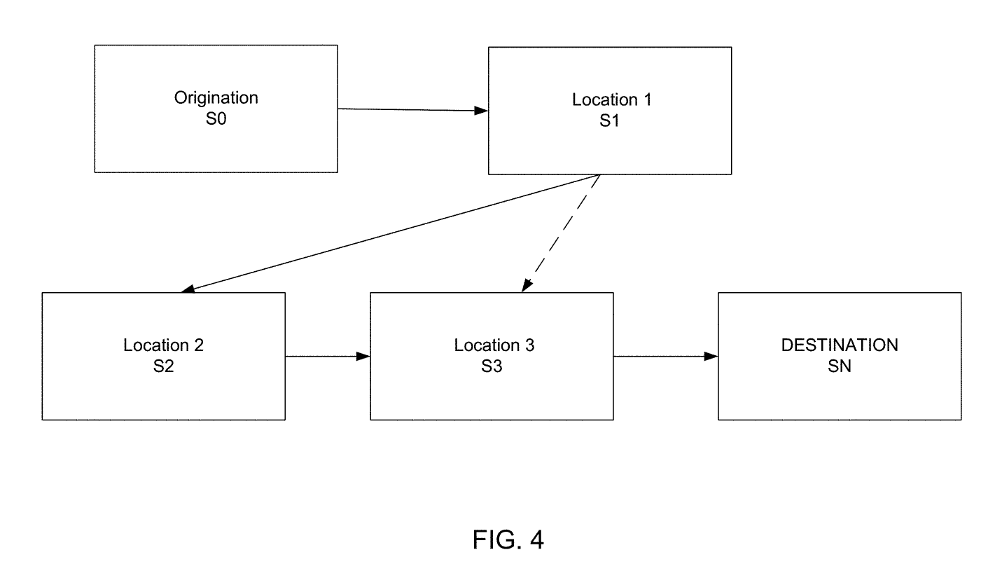

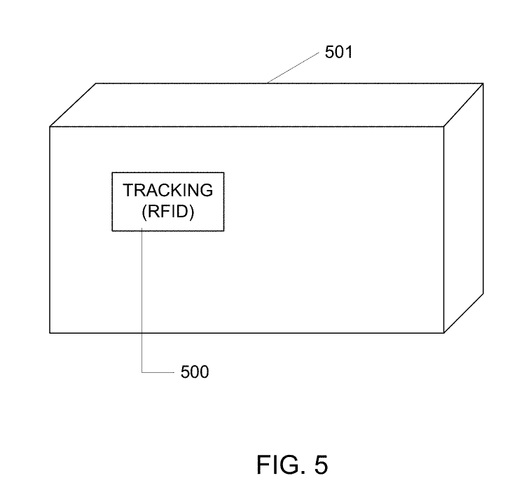

According to some aspects of the disclosure, a centralized system 300 provides various companies and patrons efficiency for electronic processing transactions and for electronic logistics tracking of a product 501 shipped (see FIG. 5) to the designated location by the purchaser. A shipping container 501 may include a tracking device 500 configured for Radio frequency identification (“RFID”). RFID Radio frequency identification (“RFID”) technologies use radio waves, microchips, and micro-antennas to read data stored in non-transitory computer readable memory, such as RAM, ROM, EEPROM, flash memory or other memory technology. RFID technologies use Machine-to-Machine (“M2M”) transmissions, which refer to direct communications between machines, such as a microchip computer readable memory, and a microchip memory scanner. In one construction, the system 300 provides electronic messaging back and forth that inputs requests for selective location designation data retrieved from the RFID device (see FIG. 4). RFID tracking device 500 could be QR code device such as a computer machine-readable optical label that contains selective information about the container 501 to which it is attached thereto. In other constructions, in lieu of an RFID technology, the device 500 can be configured or tuned for Near Field Communication (NFC) or Internet of Things (IoT) technology employing the of use radio waves, microchips, and micro-antennas to read data stored in non-transitory computer readable memory, such as RAM, ROM, EEPROM, flash memory or other memory technology. This type of technology construction can be used to track sensitive, high value and/or high dollar items/transactions for product shipments.

Referring to FIGS. 3A-3B, in one aspect, a purchaser decides to purchase a product from a vendor via the exchange system 300 as discussed in the foregoing. The system 300 may use various computer readable attribute data in the Electronic Data Interchange (EDI) format. In one implementation, the EDI message can use, for example, IPSEC circuitry for secure encrypted communications. The EDI messages can be electronically processed according any number of formats and data sequences. In one case, the EDI format and payload, may include an record number 315 (such as a transaction identification), a vendor name attribute 317, a stored value transfer amount attribute 319, and location transfer attribute data 321, and recipient designation attribute 323. The stored value transfer attribute 319 pertains to the momentary value of the transaction between the vendor and purchaser. The location transfer attribute data 321 pertains to a designated location to transfer to the next processing location, such as S1 in FIG. 4. The recipient designation attribute 323 can include physical location address. In the EDI format and payload, the “attribute data” includes ASCII characters in computer readable form or complied computer readable data. The ASCII characters can be manipulated in the software.

The steps that follow in the FIG. 4 may be implemented by one or more of the components in FIGS. 1, 2 and 3A-B and/or other components, including other computing devices.

Referring to FIG. 4, in a general overview, system 300 electronically maintains a plurality of accounts for customers associated with an entity system and a second entity system in an electronic database 121. In such an example, the separate account data attributes 500 may be stored within a non-transitory computer readable memory/database, such as memory 115 and/or RAM 105 in FIG. 1 or electronic database 307 of FIGS. 3A-3D. A purchaser decides to purchase a product from a vendor via the exchange system 300. Monetary funds are processed electronically via a digital disbursement computer readable process via electronic fund transfer (EFT) and/or ACH using information technology including a secure encrypted financial identity linked to the vendor. In one construction, the processing system 300 may disburse funds to any financial account determined to be eligible for the funds using the most effective (determine to be either cost or time) money transfer capabilities.

A temporary virtual account with EDI data payload including a transaction record attribute 315, vendor record attribute 317, and a location transfer request attribute 231 for designating a processing location (e.g., S1, S2, S3, SN of FIG. 4) of a product is generated by an exchange computer system 300. Next, a step includes electronically, via a secure computer-based data communications network, receiving EDI data payload representative of the transaction record attribute 315 and the location transfer request attribute 321. Responsive to the location transfer request attribute 325, the processing logic includes a step of transmitting, via the computer-based data communications network, EDI data payload representative of a transfer mode attribute 327 and subsequent transfer request attribute 325 for a downstream processing location (e.g., S1, S2, S3 of FIG. 4). In one construction, a temporary virtual account with virtual subaccounts may be linked with the vendor and transaction.

The steps that follow in FIG. 4 can be implemented to include a computer readable transaction history or log of the status within process flows that can be maintained or otherwise stored within a memory/database, such as memory 115 and/or RAM 105 in FIG. 1 or electronic database 307 of FIGS. 3A-3D. In one construction, the steps that follow in the FIG. 4 can be implemented where the vendor, customer or other entity can receive inquiries, via an automatic push notification or a report that sends to the authorized inquirer an electronic mail, text messaging via Short Messaging Service (SMS) component of phone, web, or mobile communication systems, using standardized communication protocols that allow the exchange of short text messages between fixed line or mobile phone devices. In another manner, the customer or entities can receive inquiries via a pull format where the inquirer initiates the query at various steps and the notification can be electronic mail or Short Messaging Service technology for cellular phones.

Referring to FIG. 4 process flow of system 300, the various items in Steps S0-S3 are electronic logically via computer readable instructions linked to electronic attribute data for EDI message processing via system 300. A purchaser executes a transaction to purchase a product by means of the exchange system 300 as discussed in the foregoing. The system 300 may then employ selective attribute data in the Electronic Data Interchange (EDI) format. For example, in Step S0, a temporary virtual account 314 is created in the memory/database 307 with at least a transaction identification 315, and a vendor name attribute 317, and a location transfer attribute data 321. A stored value transfer attribute 319 and a recipient designation attribute 323 can be optionally provided in the temporary virtual account 314. It should be noted that during if the payment transaction is not activated, that is the payment is invalid, the transaction can be cancelled the product with RFID 500 can be recalled by the vendor. Still referring to Step S0, the system 300 can determine an RFID device 500 is provided to a product 501 for subsequent processing in the logistical chain. It is noted that the temporary virtual account 314 is saved until the final delivery of the product 501, then the account 314 is deleted from memory of system 300. That is, temporary virtual account 314 is created by system 300 for the purpose of transferring the product 501 from origination to designation without the purchaser or vendor discovering the identity of each other. Optionally, prior to shipment, an infra-red camera captures item to access general condition and reduce loose returns.

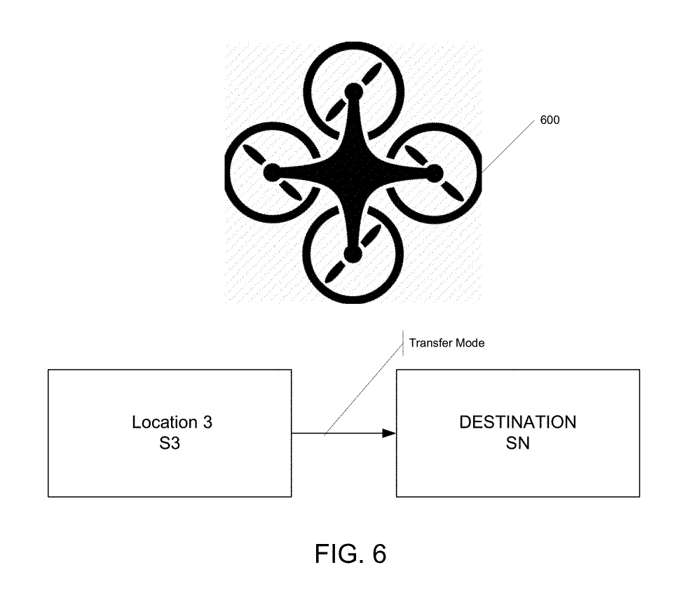

In Step S1, the product 501 arrived at location 1. The location 1 includes an RFID scanner or antenna thereon. At location 1, the product 501 is identified via “reading” (scanning or transmission of data) the RFID device 500 and contents therein. Referring to FIG. 3B, the system 300 determines the record number or transaction id 315, then determines whether to send product 501 to location 2 or location 3, in transfer location attribute 325. Furthermore, in Step S1, the transfer mode attribute 327 can be determined for transferring the product 501 to the next location. The mode attribute 327 is generated based on priority designation for speed to delivery and other features. For example, high priority, medium, or low priority can be designated based on time to reach the final destination. Optionally, prior to shipment, an infra-red camera captures item to access general condition and reduce loose returns. The mode attribute 327 can be air, ground, or sea. For air transport, the mode attribute 327 can be aircraft, or automated air drone 600 (see FIG. 6). For ground transport, the mode attribute 327 may pertain to a land-based vehicle. For ground/rail transport, the mode attribute 327 may pertain to a surface rail-based movement. For sea transport, the mode attribute 327 can be sea faring vessel, such as a ship. In Step S2, at location 2, the product 501 is identified via “reading” the RFID device 500 and contents therein. In Step S3, at location 3, the product 501 is identified via “reading” the RFID device 500 and contents therein. In Step SN, the product 501 is transferred to its final designation.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It will also be appreciated and understood that modifications may be made without departing from the true spirit and scope of the present disclosure. The description is thus to be regarded as illustrative instead of restrictive on the present disclosure.

1. An electronic computer implemented data tracking method for a product, comprising:
electronically maintaining a plurality of computer readable records in a computer readable database;
generating a temporary virtual account with EDI data payload including a transaction record attribute, vendor record attribute, and a location transfer request attribute for designating a processing location of a product;
electronically via an IPSEC computer-based data communications network tunnel, receiving EDI data payload representative of the transaction record attribute and the location transfer request attribute; and
responsive to the location transfer request attribute, transmitting, via the computer-based data communications network, EDI data payload representative of a transfer mode attribute and subsequent transfer request attribute for a subsequent physical processing location.

2. The method of claim 1, further comprising a step of scanning a RFID associated with a product associated with the transaction record attribute.

3. The method of claim 1, wherein the transfer mode attribute is representative of aircraft transport.

4. The method of claim 1, wherein the transfer mode attribute is representative of a drone transport.

5. One or more non-transitory computer readable media storing computer executable instructions that, when executed by at least one processor, cause the at least one processor to perform a digital tracking method, comprising:
electronically maintaining a plurality of computer readable records in a computer readable database,
generating a temporary virtual account with EDI data payload including a transaction record attribute, vendor record attribute, and a location transfer request attribute for designating a processing location of a product;
electronically via an IPSEC computer-based data communications network tunnel, receiving EDI data payload representative of the transaction record attribute and the location transfer request attribute; and
responsive to the location transfer request attribute, transmitting, via the computer-based data communications network, EDI data payload representative of a transfer mode attribute and subsequent transfer request attribute for a subsequent physical processing location.

6. The one or more non-transitory computer readable media of claim 5, further comprising a step of scanning a RFID associated with a product associated with the transaction record attribute.

7. The one or more non-transitory computer readable media of claim 5, wherein the transfer mode attribute is representative of aircraft transport.

8. The one or more non-transitory computer readable media of claim 5, wherein the transfer mode attribute is representative of a drone transport.

9. A digital tracking computer system for a product, comprising:
at least one computer readable database configured to maintain a plurality of computer readable records; and
at least one computing device, operatively connected to the at least one computer readable database, configured to:
generate a temporary virtual account with EDI data payload including a transaction record attribute, vendor record attribute, and a location transfer request attribute for designating a processing location of a product;
electronically via an IPSEC computer-based data communications network tunnel, receiving EDI data payload representative of the transaction record attribute and the location transfer request attribute; and
responsive to the location transfer request attribute, transmitting, via the computer-based data communications network, EDI data payload representative of a transfer mode attribute and subsequent transfer request attribute for a subsequent physical processing location.

10. The system of claim 9, wherein the at least one computing device being operatively connected to the at least one computer readable database is configured to further comprise a step of scanning a RFID associated with a product associated with the transaction record attribute.

11. The system of claim 9, wherein the at least one computing device being operatively connected to the at least one computer readable database is configured to further comprise a step of designating the transfer mode attribute being representative of aircraft transport.

12. The system of claim 9, wherein the at least one computing device being operatively connected to the at least one computer readable database is configured to further comprise a step of designating the transfer mode attribute being representative of drone transport.
